(19) United States
(12) Patent Application Publication
(10) Pub. No.: US 2017/0140381 A1
(43) Pub. Date: May 18, 2017

(54) METHOD OF ASSISTANCE IN THE AUTHENTICATION OF A USER, CORRESPONDING SERVER AND COMPUTER PROGRAM

(71) Applicant: Ingenico Group, Paris (FR)

(72) Inventors: Vincent Ducrohet, Saint Cyr L'Ecole (FR); Hiba Koudoussi, Paris (FR)

(21) Appl. No.: 15/350,823

(22) Filed: Nov. 14, 2016

(30) Foreign Application Priority Data
Nov. 13, 2015 (FR) 1560896

(51) Int. Cl. G06Q 20/40

(52) U.S. Cl. CPC G06Q 20/4014

(57) ABSTRACT

A method is provided for assistance in authentication of a user, implemented within a payment-services providing server. The method includes a phase of collecting at least one piece of operating information relative to at least one connected object preliminarily associated with the user; and a phase of managing a transaction involving bank data of the user and a merchant, comprising the following acts: processing the at least one piece of operating information collected during the phase for collecting, delivering at least one piece of data representing a level of trust associated with the transaction, and transmitting the level of trust associated with the transaction.

### 1. FIELD OF THE INVENTION

The proposed technique relates to the securing of payment transactions made by using bank data without the presence of a payment card, i.e. in “card not present” mode, for example in the case of transactions made on the internet.

The proposed technique relates more specifically to the authentication of the user during such transactions.

### 2. PRIOR ART

During transactions made for purchases on the Internet (for example using a computer, a mobile telephone or any other device capable of making such transactions) and when the user's bank card is not present (i.e. when the card is not inserted into the card reader and therefore when the data that it contains are not read via a card reader but entered by the user through a payment interface), various techniques enable the authentication of the user who holds the bank in order to verify that the use of the bank data corresponding to this card is not fraudulent (for example following theft of the card, or fraudulent copying of the data on this card).

For example, there is a known way of using an authentication method called 3D SECURE® especially to limit the risk of Internet fraud, related to attempts at identity theft, in which it is ascertained, during each online payment, that the card is being used by its true holder. Thus, when both the merchant and the bank of the card bearer are equipped, an additional step takes place at the time of payment. In addition to the bank card number, the expiry date of the card and the three security code digits (printed on the back of the card), the user must enter a password such as his birth date (simple authentication) or a dynamic one-time use code received for example on his mobile telephone (strong authentication).

Now this mechanism greatly impairs the ergonomy of such an Internet transaction for the user who is called upon either to enter a code received through his mobile phone or to enter personal data such as his birth date. This deterioration of ergonomic comfort leads to in a great increase in the rate of transactions that are interrupted because of users judging the process to be too complicated for them.

Now this authentication of the cardholder is vital to securing the transaction and makes it possible especially to assign a level of risk or trust to a transaction, this level entailing variable processing costs for the merchant.

There is therefore a need to provide a way to secure such transactions in “card not present” mode that resolves the problems of complexity, ergonomy and speed for the user as well as those of cost and security for the actors involved (merchants and bank organizations especially).

### 3. SUMMARY OF THE INVENTION

The proposed technique does not have at least some of the problems of the prior art. More specifically, the proposed technique relates to a method of assistance in the authentication of the user, a method implemented within a payment-services providing server, called a payment server and comprising:
a phase for collecting at least one piece of operating information relative to at least one connected object preliminarily associated with the user;
a phase for managing a transaction involving bank data of the user and a merchant, comprising the following steps:
   processing said at least one piece of operating information collected during the phase for collecting, delivering at least one piece of data representing a level of trust associated with the transaction;
   transmitting the level of trust associated with the transaction to at least one bank server of the merchant.

Thus, the invention proposes a novel and inventive solution for providing assistance in the authentication of a user in the context of a transaction, and more particularly a transaction in “card not present” mode making it possible especially to make up for the absence of reading of the data of the user's bank card in this type of transaction while at the same avoiding the need to require the user to perform one or more special additional actions.

Indeed, according to the different embodiments of the invention, assistance in the user's authentication is based on “automatic” surveillance or monitoring of connected objects associated with the user to increase the level of trust of the transaction (the level of trust being furthermore estimated according to prior art techniques). Thus, the level of trust granted to a transaction involving a given user is reinforced by the verification that the connected objects associated with this user are actually near the location of the transaction.

To this end, the invention, in its different embodiments, provides for the collection (periodically during a phase known as a collecting phase) of operating information (for example the presence or non-presence of a connected object, its location, etc.) of one or more connected objects associated with the user in order to make use of them at the time of the transaction proper (during a phase known as the phase for the management of the transaction), to assist in the authentication of the user while determining a level of trust associated with the transaction. This level of trust associated with the transaction is then transmitted, along with the information needed for the transaction which is also classically transmitted, to the merchant's bank server in charge of the transaction.

Thus, the information serving for assistance in the authentication of the user is collected “automatically” without intervention by the user, solely from connected objects that are preliminarily associated with him, thus making up for the drawbacks of the classic techniques of authentication of a user requiring him for example to enter a confidential code preliminarily received on his phone.

In addition, the invention in its different embodiments provides that the method will be implemented by a server providing payment services or Internet transactions services. This server manages the transactions of this type (in “card not present” mode), and communicates especially with the merchant's bank server and with the merchant (or the merchant's site) involved in the transaction.

For example, a predetermined connected object belongs to the group comprising at least:
a computer;
a personal digital assistant;
a tablet;
a smartphone;
a connected watch;
a connected bracelet.

Thus, according to this embodiment of the invention, the connected object or objects, monitored to assist in the authentication of a user, correspond to objects classically used by a user, at home or in a situation of mobility, these objects being capable of being associated with him as being located most of the time in proximity to him. In addition, the connected objects, said to be wearable in the sense of a watch, a bracelet, a health sensor for example, are objects that are all the useful and relevant for assistance in authenticating a user as they are most usually worn by the user in a truly “physical” sense.

It must be noted that the greater the number of connected objects associated with the user that can be monitored (for example a home computer, a tablet, a phone or a connected watch), the greater the relevance of the level of trust associated with the transaction.

According to one particular embodiment of the invention, the collected piece of operating information belongs to the group comprising at least:
a piece of information on activation of the connected object;
a piece of information on location of the connected object;
a piece of information on connection of the connected object;
a combination of at least two of said pieces of operating information.

Thus, according to this embodiment of the invention, the piece of information or pieces of operating information collected pertain to a “status” of the connected object, namely a status considered to be relevant for assistance in the authentication of the user such as for example a piece of information on the activation (or presence), on the connection to a local area network to which the device through which the transaction is made is also connected, or again a piece of information on location (to be compared for example with the location of the device used for the online transaction).

Indeed, the presence or absence of connected objects associated with the user is a clue or indicator that reinforces or does not reinforce the probability that the user involved in the transaction is truly the expected person, i.e. the one for whom bank card information has been communicated for the transaction in question.

It will be noted that the pieces of operating information used are variable according to the type of connected object, a piece of information on location being however probably more relevant than a piece of information on presence or connection.

It will also be noted that a combination of one or more pieces of operating information relative to a connected object can make it possible to obtain a more precise determining of the level of trust. This is the case especially, for example, when the piece of information on location can reinforce the information on presence or, on the contrary, attenuate its relevance, as for example when the connected object is detected as being connected to the home local area network but its location does not correspond to that of the device used for the transaction.

According to one particular characteristic, the step for processing a piece of collected operating information comprises the following sub-steps:
comparing the collected operating information with a piece of reference operating information, delivering a result of a comparison;
updating a level of trust associated with the transaction as a function of the result of the comparison, delivering the piece of data representing a level of trust associated with the transaction.

Thus, according to this embodiment of the invention, the piece or pieces of operating information collected (during the collecting phase) enable the updating (at the time of the transaction) of a level of trust associated with the transaction, via their comparison with one or more pieces of reference operating information.

For example, a piece of reference information corresponds to a “worn” state, a state of connection to a predetermined network or again a location of the device through which the transaction is implemented (a phone or a computer for example).

Thus, when the collected operating information, for a given connected object, indicates that it is present or connected to the home local area network, and when the device used for the transaction is also connected to this same network, this reinforces the level of trust of the transaction. Similarly, when the collected piece of operating information, corresponding to a location of a given connected object, is similar to or near location of the device through which the transaction is made, this reinforces the level of trust of the transaction.

On the contrary, if a connected object associated with the user is absent or located at a distance beyond the predetermined threshold for the device on which the user is making his transaction, this reduces the level of trust of the transaction.

According to one particular aspect, the updating of the level of trust also takes account of at least one criterion belonging to the group comprising:
a piece of data representing the transaction;
a category to which the connected object belongs;
a context of implementation of the transaction;
a combination of at least two of said above criteria.

Thus, according to this embodiment of the invention, the updating of the level of trust associated with the transaction takes account not only of the collected piece or pieces of operating information for the connected objects considered, but also:
one or more pieces of transaction data coming from the merchant (or from the merchant's site, for example the amount of the transaction, the type of product concerned, the delivery address, the type of bank card used, etc.), conventionally used to evaluate a level of trust (also called a “risk score” obtained by “risk scoring”) of a transaction. The level of trust delivered by the processing step then corresponds to a level of trust classically computed and updated through the method of the invention;
the category of the connected objects for which the piece or pieces of operating information have been collected. Thus, several categories of connected objects to be monitored can be defined, such as for example:
   objects “essential” or highly relevant to the implementation of the method of authentication according to the invention because these are the objects nearest to the user, ideally objects that are “physically” worn by the user (for example a connected watch),
   objects “non-essential” or less essential but providing for a finer definition of the level of trust, not “physically” worn by the user but capable of being associated with him or her in classic operation at home for example (for example a computer or a tablet);
a context/use of transaction: at home (the location is then a piece of operating information that can be easily exploited), in a situation of mobility (the location is then less reliable but a complementary piece of data relative for example to the vehicle used can be useful or worthwhile).

According to one particular characteristic, the phase for collecting comprises:
a step of registration of at least one identifier and one collection characteristic for the connected object in at least one data base attached to the payment server, and

at least one iteration of the following steps:
collecting said at least one piece of operating information associated with said at least one connected object associated with the user, this action of collecting using said at least one registered collection characteristic;
time-stamping said at least one piece of collected operating information and updating the data base with said at least one piece of time-stamped, collected operating information.

Thus, according to this embodiment of the invention, a preliminary step for registering connected objects used for assistance in authenticating a user enables the storage, in a data base, of the identifier of a connected object and a characteristic associated with this object, so as to then enable the collection of operating information associated with connected objects, preliminarily registered in the data base.

Then, during the collection phase proper, the data base is updated with pieces of operating information collected (for example periodically or upon a request from the payment server) time-stamped for their exploitation during the transaction phase.

To this end, the characteristic or characteristics associated with a connected object during the preliminary registering step enable the definition of the “modalities of collection” of the piece or pieces of operating information associated with this object. For example, one collection characteristic corresponds to an IP address of a computer, a SIM (subscriber identity module) number of a portable phone, pairing data for a Bluetooth® type connection, WI-FI access point data, etc. This characteristic can vary according to the type of connected object and makes it possible to obtain the corresponding piece of operating information such as the presence of the object, the connection of the object, the location of the object, etc.

The time-stamping for its part enables verification that the operating information collected is relevant to the time of the transaction.

For example, the phase for managing a transaction is activated by the reception of at least one message coming from a device carrying out the transaction involving the user's bank data.

Thus, according to this embodiment of the invention, it is when the payment server receives data on a transaction in progress (for example data on an amount, type of card used, card number and expiry date, security code, merchant site concerned, etc.) and when the card data corresponds to a card benefiting from the method of assistance with user authentication, which is the object of the present invention, that the transaction phase proper of this method is activated.

It is therefore when the payment server receives a message that the data collected during the preliminary collection phase are processed.

The invention also relates to a payment-services providing server implementing the method of assistance with authentication of a user as described above, the payment-services providing server comprising:
a collecting module, comprising at least one receiver capable of collecting at least one piece of operating information pertaining to at least one connected object preliminarily associated with the user;
a management module for managing a transaction involving bank data of the user and a merchant, comprising:
   a module for processing said at least piece of collected operating information, delivering at least one piece of data representing a level of trust associated with the transaction;
   a transmission module, comprising at least one transmitter capable of transmitting the level of trust associated with the transaction to at least one bank server of the merchant.

Such a payment server also called a server providing Internet transaction services corresponds to a server in charge of online transactions and also additional securing methods required for a transaction, such as the 3D SECURE® technique.

According to one preferred implementation, the different steps of the methods according to the proposed technique are implemented by one or more software programs or computer programs comprising software instructions to be executed by a data processor of a relay module accordingly to the invention and being designed to control the execution of the different steps of the methods.

The invention is therefore also aimed at providing a computer program downloadable from a communications network and/or stored in a computer-readable carrier and/or executable by microprocessor, liable to be executed by a computer or a data processor, this program comprising instructions to command the execution of the steps of a method as mentioned here above.

This program can use any programming language whatsoever and can be in the form of source code, object code or intermediate code between source code and object code, such as in a partially compiled form or in any other desirable form.

The invention is also aimed at providing an information carrier readable by a data processor and comprising instructions of a program as mentioned here above.

The information carrier can be any entity or device whatsoever capable of storing the program. For example, the carrier can comprise a storage means such as a ROM, for example a CD ROM or a microelectronic circuit ROM or again a magnetic recording means, for example a floppy disk or a hard disk drive.

The information carrier can also be a transmissible carrier such as an electrical or optical signal which can be conveyed via an electrical or optical cable, by radio or by other means. The program according to the invention can especially be uploaded to an Internet type network.

As an alternative, the information carrier can be an integrated circuit into which the program is incorporated, the circuit being adapted to executing or to being used in the execution of the method in question.

According to one embodiment, the invention is implemented by means of software and/or hardware components. In this respect, the term “module” can correspond, in this document, equally well to a software component and to a hardware component or to a set of hardware and software components.

A software component corresponds to one or more computer programs, one or more sub-programs of a program or more generally to any element of a program or a piece of software capable of implementing a function or a set of functions according to what is described here below for the module concerned. Such a software component is executed by a data processor of a physical entity (terminal, server, gateway, router, etc) and is liable to access the hardware resources of this physical entity (memories, recording carriers, communications buses, electronic input/output boards, user interfaces, etc

In the same way, a hardware component corresponds to any element of a hardware unit capable of implementing a function or a set of functions as described here below for the module concerned. It can be a programmable hardware component or a component with an integrated processor for the execution of software, for example an integrated circuit, a smartcard, a memory card, an electronic board for the execution of firmware, etc.

Each component of the system described here above naturally implements its own software modules.

The different modules described here above can be combined with each other to implement the proposed technique.

### 1. FIGURES

Other features and advantages of the proposed technique shall appear more clearly from the following description of a preferred embodiment, given by way of a simple illustratory and non-exhaustive example and from the appended drawings, of which:

FIG. 1 illustrates the main steps of the method for assistance in the authentication of a user according to one particular embodiment of the invention;

FIG. 2 represents an example of a system in which the invention can be implemented according to one particular embodiment;

FIG. 3 illustrates a sequence diagram of one particular embodiment of the invention;

FIGS. 4 and 5 illustrate two examples of simplified architectures of a payment-services providing server for the implementation of the method for assistance in the authentication of a user according to one particular embodiment of the invention.

### 4. DESCRIPTION

### 4.1. General Principle

The general principle of the proposed technique consists of the use of the connected objects associated with the user to assist in his or her authentication during a transaction involving bank data associated with one of his or her bank cards or one of his or her bank accounts, this transaction being implemented in “card not present” mode.

More specifically, the general principle is based on verifying that connected objects, preliminarily associated with a given user, are present at or near the location of the transaction (i.e. near the device through which a transaction is made) at the time of this transaction and therefore that the cardholder is truly the expected individual.

Indeed, if a user U uses his bank card to make an online purchase and if it can be verified that his connected watch is truly on his wrist, that his smartphone is truly in his pocket and that the computer on which the transaction is taking place is truly the computer associated with this user, then it is probable that the bank card is being validly used by the user U.

On the contrary, if the bank card of this user U has been stolen or if the information pertaining to this card has been fraudulently retrieved, then, when this information is being used for a transaction, for example by a malicious third party carrying out this transaction on his own computer, then it is probable that the connected objects associated with the user holding this bank card are not present at or near to the location of the transaction.

To this end, the invention in its different embodiments is implemented by a payment-services (or Internet transaction services) providing server, here below called a payment server, communicating with the different connected objects associated with the user as well as the merchant proposing the transaction and this merchant's bank server.

Thus, pieces of information called operating information, associated with a user's connected objects user, are used to find out, for example, if a connected object is present or connected to a given network or located near the place of the transaction, etc.

The invention therefore provides for a preliminary phase prior to the transaction proper, enabling the collection of these pieces of operating information relating to these different connected objects associated with the user.

This first phase, called a collecting phase, comprises especially a step for registering all the connected objects associated with the user, for example in a data base of the payment server implementing the method, enabling not only the referencing of these connected objects but also their association with the characteristics useful and necessary for the collection of operating information pertaining thereto.

Then, during a phase for managing the transaction proper, the collected pieces of operating information are processed to update a level of trust associated with the transaction, this level of trust being then transmitted, along with “classic” transaction information, to the merchant's bank server. This server then evaluates the transaction, for example in the form of a “risk profile” subsequently intended to be exploited by the payment server which uses the information provided by the merchant's site to determine a “transaction cost” making it possible to decide whether or not the transaction is sufficiently secured. To this end, the merchant's site defines for example an acceptable level of cost (a threshold) below which additional securing must be implemented by the payment server, or else a transaction must be rejected (there can be two thresholds for example).

### 4.2. Description of One Embodiment

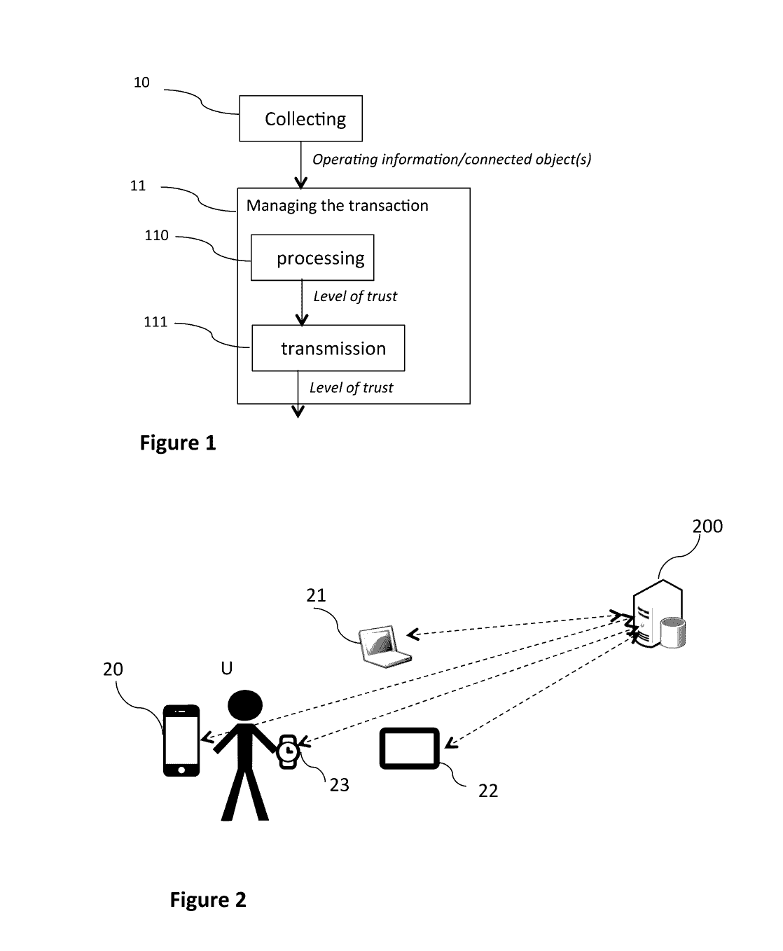

Referring now to FIGS. 1 to 3, we describe the main steps of the method for assistance in authentication according to a first embodiment of the invention, for a given user (denoted U here below) with whom connected objects 20 to 23 (illustrated in FIG. 2) are associated.

Thus, in the present example, the user U is deemed to possess the following connected objects: a smartphone 20, a computer 21, a tablet 22 and a connected watch 23, these connected objects being capable of being used for assistance in authenticating the user during subsequent transactions implementing one of his bank cards.

As already indicated above, the main steps of the method of the invention are grouped into two phases: a collecting phase 10 and a phase for managing a transaction 11.

The collecting phase 10 enables the collection of the operating information associated with the different connected objects of the user, after they have been preliminarily registered, for example in a data base of the payment server 200.

Thus, this recording makes it possible to define the objects associated with a given user, in this example the user U, as well as the “modalities” of the collection of operating information relating to these connected objects.

For example, the above-mentioned connected objects 20 to 23 are referenced, within the server 200 with the following characteristics enabling the subsequent collection of operating information relevant to assistance with authentication of the user U:
the smart phone 20 is characterized by an identifier (for example the IMSI (International Mobile Subscriber Identity) identifier of the SIM card (Subscriber Identity Module card)), this identifier making it possible especially to know the location of the smartphone 20 via the communications network to which it is connected;
the computer 21 is characterized by a serial number and an IP address (Internet Protocol address), the IP address making it possible especially to know whether the computer is connected or not, as well as to know its location;
the tablet 22 is characterized also by a serial number and an IP address;
the connected watch 23 is characterized by the fact that it is activated (therefore on the user's wrist) and by pairing data (for example pairing with the smartphone 20) for Bluetooth® communications, these data for pairing with the smartphone making it possible especially to find out if the watch is being truly worn by the user (or even to enter into communication with it to find out its location); indeed, a connected watch that is not being worn is not active. By contrast, when the user puts it on his wrist, the watch detects the fact that it is being worn (generally through a biometric sensor) and then displays a code (for example a four-digit code) which the user must enter on his smartphone. Whenever the watch is removed and then put back, it is necessary to carry out the same operation. Thus, it is possible to verify that the watch is truly being worn (hence synchronized with the smartphone which is truly the user's smartphone).

To implement this step of preliminary registration, the user U, acting on a proposal by the banking organization that manages his cards and bank accounts, can for example download an application on to one or more devices (for example his smartphone, his computer and/or his tablet) making it possible to reference these connected objects.

This registration step can be followed by a step of verification, for example via a test of the modalities of collection, to initiate a first collecting of operating information about the registered connected objects.

Thus, the application implements a first “interrogation” of the different referenced connected objects via the associated characteristics, in order to test whether they effectively enable the collection of operating information for each object. Thus for example, the application verifies that, from the IP address registered for the computer, it is effectively possible to detect that the computer is present and to determine its location. The same is true for the tablet for example. As for the smartphone, the application can verify that the registered identifier truly corresponds to an existing device and enables the location of this device. Finally, as far as the connected watch is concerned, the application can try and enter into Bluetooth® communications, via the registered pairing data, in order to verify that the watch is truly connected (i.e. worn by the user) or even to verify that it has responded to a previous request or call.

In addition, this application can also enable the user to parametrize the collection phase, for example with respect to the frequency of collection of the operating information. Indeed, the frequency with which the operating information is updated can be parametrized, for example according to criteria such as the frequency of online payments made by the user, or again the degree of mobility of this user so that the information collected is as relevant as possible when a transaction is initiated (a piece of information on location dating from several hours is obviously less relevant than a piece of information or location obtained in the minutes preceding the transaction for example).

Depending on each user's habits and practices, this application can be installed preferably on a mobile device when the user makes mainly online purchases in a situation of mobility or on a device such as a home computer when the user makes mainly online purchases from home.

It must be noted that this step of registration can be reiterated at any time for example when the user wishes to reference another connected object or eliminate a referenced connected object which he is no longer using, etc. The collecting phase proper then takes account of each updating of the data base.

Once this first step of registering has been done, the collecting phase 10 proper is updated according to the parametrized periodicity (for example once every hour or three times per day etc.).

When a piece of operating information is collected for a given connected object, it is time-stamped and stored in the data base of the payment server. Thus, this gives the following, for example for the connected objects registered above for the user U:

| | | |
|---|---|---|
| smartphone 20/ | locationL123/14h00 | Reference = location of the |
| IMSI123 number | locationL123/14h30 | transaction-making device |
| computer 21/serial | locationL456-IP1/ | Reference = location of the |
| number 456/address | 14h00 | transaction-making device |
| IP1 | locationL456-IP1/ | |
| | 14h15 | |
| | locationL456-IP1/ | |
| | 14h30 | |
| tablet 22/789 serial | locationL789-IP2/ | Reference = location of the |
| number/address IP2 | 14h00 | transaction-making device |
| | locationL789-IP2/ | |
| | 14h30 | |
| Connected watch 23/ | presenceLaaa/14h00 | Reference = watch worn |
| pairing code aaa | presenceLaaa/14h15 | |
| | presenceLaaa/14h30 | |

As illustrated in the above table, the data base can show a timeline of operating information collected as a function of periodicity, or keep only the last piece of operating information collected. This for example can be part of the parametrization proposed to the user when he installs the above-mentioned application.

Then, when a bank card, or pieces of bank data, preliminarily associated with the user U are involved in a transaction in “card not present” mode, for example an online transaction, the phase for managing the transaction 11 is implemented.

Here below, we describe two cases of use of such a transaction in which the bank data of the user U are used by himself (this is the first case of use) or used by a malicious third party after identity theft, i.e the theft of a card or the copying of bank data (this is the second case of use).

a) Description of a First Case of Use

In this first case of use, the user U is considered to be making a transaction online on his computer 21.

As illustrated in FIG. 1, the phase 11 for managing the transaction comprises a first processing step 110 for processing one or more pieces of operating information preliminarily collected during the collecting phase 10, for one or more of the connected objects associated with the user so as to deliver a piece of data representing a level of trust associated with the transaction in progress.

This processing step 110 can include several sub-steps (not illustrated) used to compute this piece of data representing a level of trust in also taking account possibly of other parameters related to the transaction proper (parameters often given by the merchant or the merchant site described in greater detail here below).

Thus, in the present example, the data on location collected for the first three connected objects 20 to 22 are compared with the location of the device through which the transaction is being made, in this case the computer 21 of the user U.

When the location of one of the connected objects associated with the user corresponds or is near that of the computer 21, a positive comparison result is delivered. The comparison of locations can conventionally implement a predetermined threshold, below which it is estimated that the locations are proximate and beyond which, on the contrary, it is estimated that the locations are far too distant for the goal of the present invention.

As regards the connected watch, if the operating information collected indicates that the watch is being worn (which corresponds to the reference information for this type of object), then a positive comparison result is also delivered.

These comparison results are then used to update a level of trust associated with the transaction and thus deliver the piece of data representing a level of trust.

For example, if we consider a level of trust corresponding to a figure situated between zero and ten (ten being the maximum level of trust), it can be envisaged that each positive comparison result increments a default level of trust equal to five by one unit and that, on the contrary, each negative comparison result decrements the level of trust by one unit. In this case, the data representing a level of trust can correspond itself to a figure situated between zero and ten. It is also possible, according to the algorithm implemented, that certain comparison results represent a weighting that is greater than the others, for example depending on the category of the connected object, as described below.

Any other mode of updating the level of trust that makes it possible to take account of the operating information collected for the connected objects associated with the user U can be defined. Thus, the piece of data representing a level of trust can correspond to a percentage reflecting risk.

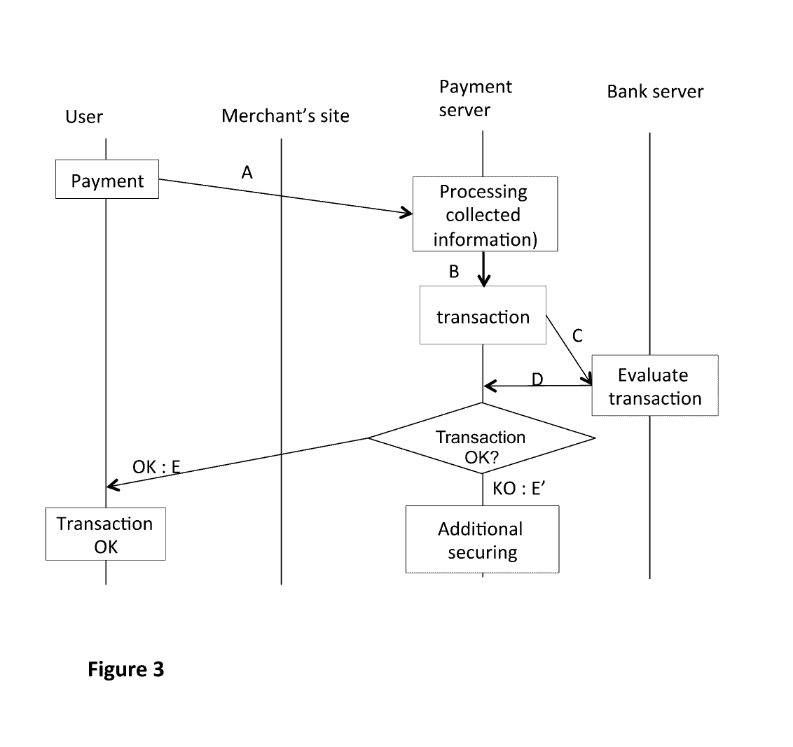

Whatever the form that can be taken by the level of trust, the merchant defines the level starting from which he decides to accept transactions, reject them or request additional checks, as detailed further below with reference to FIG. 3.

Besides, the level of trust updated according to the results of comparison described above can also take account of complementary criteria/parameters such as:
a piece of data representing the transaction: for example one or more pieces of data coming from the merchant or the merchant's site (the amount of the transaction, the type of product concerned, the delivery address, the type of bank card used etc.) classically used to evaluate a level of trust (the “risk score” obtained by “risk scoring) of a transaction;
a category of membership of the connected object: for example, a connected object truly worn by the user (such as a watch or a bracelet) can be classified as a “priority” object, the comparison result of which can have greater importance in the updating of the level of trust than that of a “non priority” object (such as a smartphone); in this case and for the example described above, the comparison result for a priority object could increment the level of trust by two units;
a context of implementation of said transaction: for example additional data for identifying the vehicle in which the user is situated at the time of the transaction in a situation of mobility (identity of vehicle owner, location relative to predetermined routes (home-to-workplace for example)).

A combination of several complementary parameters/criteria described here above can of course be used in such a way as to reinforce the relevance of the level of trust.

In addition, these complementary parameters/criteria can for example be used to determine the “default” level of trust, i.e. the level of trust before implementing the invention and using collected operating information, or they can be used to increment or decrement a predetermined default level of trust.

Finally, these complementary parameters/criteria can come from predetermined sensors and/or data sources, implemented in the framework of the present invention, such as for example sensors used to locate the user's vehicle.

Once this piece of data representing a level of trust has been delivered, it is transmitted, during a transmission step 111 to the merchant's bank server. This piece of data representing a level of trust can be transmitted at the same time as transaction data classically transmitted by the payment server to the merchant's bank server.

Indeed, during a “classic” known transaction in “card not present” mode, a payment server transmits information on transactions to the merchant's bank server. This is information such as the merchant, the amount, the card data (holder's forename and surname, number, expiry date, security code), date and time of the transaction, type of transaction (authorization, capture, etc.) as well as a “security score” coming from a computation that takes account of parameters essentially provided by the merchant or the merchant's site (the type of product concerned, the delivery address, the type of bank card used). As described here below with reference to FIG. 3, this information is used by the merchant's bank server to assess a cost of processing the transaction, which the bank server sends to the payment server. The payment server uses this information to determine a cost of processing of the transaction on the basis of the data preliminarily provided by the merchant or merchant site. For example, this information corresponds to one or more thresholds beyond which the cost of processing is considered to be too high to accept the transaction as it is.

Thus, there are for example several possibilities for managing the transaction, depending on the cost of processing evaluated by the payment server:
the risk is low: then the payment server sends details of the transaction (amount, card number, etc.) to the bank server;
the risk is high: then the payment server starts a 3D SECURE® type additional step with the consumer;
the risk is very high: then the payment server rejects the transaction and the consumer is alerted to it.

The method of the invention for assistance in authentication, according to its different embodiments, therefore reinforces the level of trust associated with the transaction so as to refine the processing cost computed by the merchant's bank server without additional action by the user thus ensuring ergonomic efficiency of the online transaction unlike the known, prior-art techniques.

A more detailed description is now given, with reference to FIG. 3, of the different exchanges implemented between the consumer, the merchant or the merchant's site, the payment server implementing the invention and the merchant's bank server.

In a first stage, the user U classically enters the data required for the payment of an object or a service on a merchant's site, and especially bank card data (number, expiry date, security code). These data are transmitted to the payment server (sequence A) thus activating the transaction phase proper of the method for assistance in authentication according to this embodiment of the invention.

To this end, the payment server detects that the transmitted bank data corresponds to preliminarily registered data of the user U, benefiting from this service of assistance with authentication according to the invention. The payment server then interrogates the data base (internally or through a network enabling access to this “externalized” data base) comprising especially time-stamped operating information collected for the connected objects associated with this user U. The payment server then implements the first step of this transaction phase which consists in processing this operating information preliminarily collected for connected objects associated with the user U. As described above, this processing makes it possible to determine a piece of data representing a level of trust associated with the transaction (sequence B). This piece of data is used by the payment server to carry out the transaction in creating the payment message that will be transmitted to the merchant's bank server (also called the merchant's “acquiring bank”).

Then, this transaction is transmitted (sequence C) to the merchant's bank server, with the piece of data representing the associated level of trust. As a reminder, this piece of data representing the level of trust associated with the transaction can take a classic form of a level of trust, also called a “risk score” obtained by “risk scoring”, reinforced/refined by the use of the connected objects associated with the user according to the present invention

The merchant's bank server then implements an evaluation of the transaction received from the payment server, this evaluation being known per se. As described here above, this gives a cost of processing the transaction, intended to enlighten the payment server as to a possible additional securing to be implemented for the transaction in progress. This processing cost is therefore transmitted (sequence D) to the payment server by the merchant's bank server.

The payment server then analyzes the cost of processing the transaction, on the basis especially of information provided by the merchant's site or the merchant, and decides whether the transaction can be validated (sequence E), which corresponds to the first case of use, or whether it is necessary to carry out an additional securing (of the 3D SECURE® type for example) (sequence E′) (second case of use described below) or again whether the transaction is rejected.

According to this first case of use, the transaction is therefore validated without requiring any additional securing and the user then has the benefit of an online payment service that is at the same time secured, speedy and practical, not requiring any additional step to enter complementary data as with the implementation of the 3D SECURE® system for example.

b) Description of a Second Case of Use

If we take, this time, a second example in which the bank data of the user U have been stolen by a malicious third party, the sequences of FIG. 3 take place in the way described here below.

The user's stolen bank data are entered on the merchant's site and transmitted (sequence A) to the payment server, as in the first example of use. This reception by the payment server activates the phase of transaction of the method of the invention, which begins by the processing of operating information collected for connected objects associated with the user U.

In a first variant, it is not possible to locate the device through which the transaction is being made (i.e. the computer or the smartphone of the malicious third party who has stolen the bank data of the user U). For example, the IP address of this device is not accessible, or does not enable location, or the serial number is unknown. This situation gives rise to negative results for the comparisons of proximity of the connected objects, made through their preliminarily collected operating information, delivering a low or even zero level of trust for the transaction in progress. Indeed, since no reference information is available for the location of the transaction, any comparison of a location of a connected object with a piece of reference information that is not available delivers negative result of comparison. In the case of the user U and the connected objects 20 to 22, several comparisons therefore deliver negative results and the level of trust associated with the transaction is therefore highly downgraded or even equal to zero.

In a second variant, the IP address of the device through which the transaction is made (i.e. the computer or the smartphone of the malicious third party who has stolen the bank data of the user U) makes it possible to determine its location. This location, which does not correspond to the device registered by the user U, can therefore serve as a reference for the comparisons with the collected locations of the connected objects associated with the user. Naturally, these comparisons are also negative because it is improbable that the device of the malicious third party will be near the connected objects of the user U. Here again, the level of trust associated with the transaction in progress is low, or even zero.

The piece of data representing a level of trust associated with the transaction is therefore determined (sequence B) and then used by the payment server to carry out the transaction.

As in the first case of use described above, this transaction with the piece of data representing the associated level of trust is transmitted (sequence C) to the merchant's bank server.

The merchant's bank server then makes an evaluation of the transaction received from the payment server, this evaluation being known per se. This gives a cost of processing of the transaction intended to enlighten the payment server as to a possible additional securing to be carried out for the transaction in progress. This processing cost is therefore transmitted (sequence D) to the payment server by the merchant's bank server.

In the second case of use, since the level of trust associated with the transaction in progress is low or even zero, because of the non-authentication of the user U via his connected objects, the cost of processing the transaction is very high. The payment server then decides that the cost is too high and requests (sequence E′) additional securing or else it rejects the transaction.

If there is a request for additional securing, then a 3D SECURE® type securing operation, for example, is implemented through the transmission of a one-time use code on a device preliminarily registered as belonging to the user U so that the latter, upon reception, enters it on the merchant's site. Now, in this second case of use, this code cannot be received by the malicious third party who has initiated the payment, and who therefore cannot respond to the securing operation requested. The transaction therefore cannot be concluded.

In this case of theft of the bank data of the user U, the method of the invention for assistance in authentication of the user has therefore prevented a fraudulent transaction by using operating information collected for connected objects associated with the user U.

It is possible to implement various different alternative embodiments of the invention, relating for example to connected objects, collected operating information, the processing of the collected operating information or again the type of level of trust used inasmuch as they respond to the problems of securing transactions in “card not present” mode while meeting problems of complexity, ergonomy, and speed for the user as well as questions of cost and security for all the actors involved (merchants and banking organizations especially). These different alternative embodiments are not described in the present application.

### 4.3. Payment-Services Providing Server

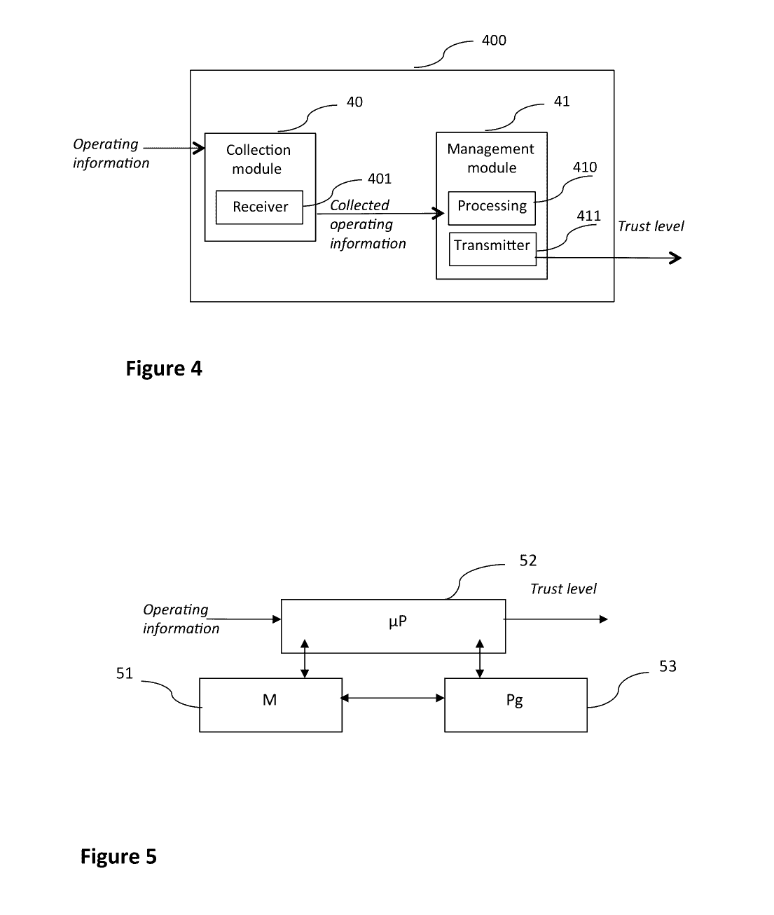

Referring now to FIGS. 4 and 5, we present two examples of simplified architectures of a payment-services providing server 400 for the implementation of the method for assistance in authentication of the user according to one of the embodiments of the invention.

For example, such a payment server 400, called a payment server, comprises:
a collecting module 40 comprising at least one receiver 401 of at least one piece of operating information about at least one connected object preliminarily associated with the user; for example, such a receiver 401 is capable of receiving data through a wired or wireless communications network to which the payment server 400 as well as the user's connected objects are connected;
a management module 41 for managing a transaction involving the user's bank data and a merchant, comprising:
   a processing module 410 for processing at least one piece of collected operating information, delivering at least one piece of data representing a level of trust associated with the transaction; for example such a processing module 410 is capable of recovering data in a data base and comparing it with information on location;
   a transmission module comprising a transmitter 411 to transmit the level of trust associated with the transaction to at least one bank server of the merchant; for example, such a transmitter 411 is capable of transmitting data through a wired or wireless communications network to which the payment server 400 as well as the merchant's bank server are connected.

Such a payment server 400 corresponds for example to a payment server classically used in the context of online transactions, especially in “card not present” mode adapted to implementing the method for assistance in the authentication of a user, according to the different embodiments of the invention

As illustrated in FIG. 5, such a payment server 400 comprises for example a memory 51 constituted by a buffer memory, a processing unit 52 equipped for example with a microprocessor and driven by the computer program 53, necessary for implementing the method for assistance in the authentication of the user according to the different embodiments of the invention.

At initialization, the code instructions of the computer program 53 are for example loaded into a memory and then executed by the processor of the processing unit 52. The processing unit 52 inputs for example one or more pieces of operating information, associated with one or more connected objects preliminarily associated with the user. The microprocessor of the processing unit 52 implements the steps of the method for assistance in the authentication of the user according to the instruction of the computer program 53 to enable the collection of these pieces of operating information and then the management of a transaction involving the user's bank data (the processing of the collected operating information and then the determining of a level of trust associated with the transaction and transmission of a piece of data representing this level of trust to a bank server of the merchant).

To this end, the payment server comprises, in addition to the buffer memory 51, a collecting module 40 comprising at least one receiver 401, a management module 41 for managing a transaction, comprising a processing module 410 and a transmission module comprising a transmitter 411, as described above.

These modules can be driven by the processor of the processing unit 52 according to the computer program 53.

1. A method of assistance in authentication of a user, said method being implemented within a payment-services providing server, called a payment server, said method being comprising:
a phase of collecting at least one piece of operating information about at least one connected object preliminarily associated with said user; and
a phase of managing a transaction involving bank data of said user and a merchant, comprising the following acts:
processing said at least one piece of operating information collected during said phase of collecting, delivering at least one piece of data representing a level of trust associated with said transaction; and
transmitting said level of trust associated with said transaction to at least one bank server of said merchant.

2. The method of assistance in the authentication of a user according to claim 1, wherein said predetermined connected object belongs to the group consisting of:
a computer;
a personal digital assistant;
a tablet;
a smartphone;
a connected watch;
a connected bracelet.

3. The method of assistance in the authentication of a user according to claim 1, wherein said collected piece of operating information belongs to the group consisting of:
a piece of information on activation of said connected object;
a piece of information on location of said connected object;
a piece of information on connection of said connected object;
a combination of at least two of said pieces of operating information.

4. The method of assistance in the authentication of a user according to claim 1, wherein said act of processing a piece of collected operating information comprises the following sub-acts:
comparing said collected operating information with a piece of reference operating information, delivering a result of a comparison;
updating a level of trust associated with said transaction as a function of said result of comparison, delivering said piece of data representing a level of trust associated with said transaction.

5. The method of assistance in the authentication of a user according to claim 4, wherein said updating of said level of trust also takes account of at least one criterion belonging to the group consisting of:
a piece of data representing said transaction;
a category to which said connected object belongs;
a context of implementation of said transaction;
a combination of at least two of said above criteria.

6. The method of assistance in the authentication of a user according to claim 1, wherein said phase of collecting comprises:
registration of at least one identifier and one collection characteristic for said connected object in at least one data base attached to said payment server, and
at least one iteration of the following acts:
collecting said at least one piece of operating information associated with said at least one connected object associated with said user, this action of collecting using said at least one registered collection characteristic; and
time-stamping said at least one piece of collected operating information and updating said data base with said at least one piece of time-stamped, collected operating information.

7. The method of assistance in the authentication of a user according to claim 1, wherein said phase of managing a transaction is activated by reception of at least one message coming from a device carrying out said transaction involving said bank data of said user.

8. A payment services providing server implementing a method of assistance in authentication of a user, said payment-services providing server comprising:
a collecting module, comprising at least one receiver capable of collecting at least one piece of operating information pertaining to at least one connected object preliminarily associated with said user; and
a management module configured to manage a transaction involving bank data of said user and a merchant, comprising:
a processing module, which processes said at least piece of collected operating information, delivering at least one piece of data representing a level of trust associated with said transaction; and
a transmission module, comprising at least one transmitter which transmits said level of trust associated with said transaction to at least one bank server of said merchant.

9. A non-transitory computer-readable medium comprising a computer program stored thereon, wherein the program comprises program code instructions to execute a method of assistance in authentication of a user according the instructions are executed by a processor of a payment-services providing server, wherein the instructions configure the a payment-services providing server to perform acts comprising:
a phase of collecting at least one piece of operating information about at least one connected object preliminarily associated with said user; and
a phase of managing a transaction involving bank data of said user and a merchant, comprising the following acts:
processing said at least one piece of operating information collected during said phase of collecting, delivering at least one piece of data representing a level of trust associated with said transaction; and
transmitting said level of trust associated with said transaction to at least one bank server of said merchant.
